(19) United States
(12) Patent Application Publication
(10) Pub. No.: US 2015/0084939 A1
(43) Pub. Date: Mar. 26, 2015

(54) METHOD FOR REDUCING POWER CONSUMPTION OF LIQUID CRYSTAL DISPLAY SYSTEM

(71) Applicant: Chunghwa Picture Tubes, Ltd., Taoyuan (TW)

(72) Inventors: Cheng-Ping Chen, Taoyuan County (TW); I-Ching Wei, Miaoli County (TW)

(73) Assignee: Chunghwa Picture Tubes, Ltd., Taoyuan (TW)

(21) Appl. No.: 14/083,417

(22) Filed: Nov. 18, 2013

(30) Foreign Application Priority Data
Sep. 25, 2013 (TW) 102134623

(51) Int. Cl. G09G 3/36

(52) U.S. Cl. CPC G09G 3/3674; G09G 3/3685; G09G 2310/08
USPC 345/204; 345/99

(57) ABSTRACT

A method for reducing power consumption of a liquid crystal display system includes: a timing controller receiving an image signal of a frame; the timing controller generating a gate control signal and a source control signal according to the image signal; a gate driving circuit driving odd scan lines of a plurality of scan lines in turn and then driving even scan lines of the plurality of scan lines in turn according to the gate control signal; and a source driving circuit charging a plurality of sub pixels included in a liquid crystal panel through a plurality of data lines according to the source control signal, driving sequence of the plurality of scan lines, and data voltages corresponding to the image signal. Voltages of the plurality of data lines are switched one time at most, and a common voltage of the liquid crystal panel is a direct current voltage.

### BACKGROUND OF THE INVENTION

1. Field of the Invention

The present invention relates to method for reducing power consumption of a liquid crystal display (LCD), and more particularly to a method that can change a sequence of a gate driving circuit driving a plurality of scan lines and accordingly change a sequence of a source driving circuit outputting data voltages corresponding to an image signal of a frame to reduce the power consumption of the LCD system.

2. Description of the Prior Art

Please refer to FIG. 1, which is a diagram illustrating a liquid crystal panel 100 with a dot inversion. As shown in FIG. 1, sub pixels coupled to the same data line are arranged in a Zig-Zag shape as denoted by dotted lines as shown in FIG. 1, wherein polarities of each two adjacent sub pixels of the liquid crystal panel 100 are reverse. Taking a data line DL for example, green sub pixels 101, 105, . . . and red sub pixels 103, 107, . . . are coupled to the data line DL, wherein a scan line S1 controls a switch coupled to the green sub pixel 101, a scan line S2 controls a switch coupled to the red sub pixel 103, a scan line S3 controls a switch coupled to the green sub pixel 105, a scan line S4 controls a switch coupled to the red sub pixel 107, and so on. Hence, the sub pixels of the liquid crystal panel 100 are driven in the Zig-Zag shape.

As shown in FIG. 1, an advantage of using the Zig-Zag shaped driving method is that the liquid crystal panel 100 can display one dot driving effect. However, a disadvantage of the liquid crystal panel 100 is that when the liquid crystal panel 100 displays a mono-color frame or a mixed color frame, since the polarities of the adjacent sub pixels are reverse, a source driving circuit of the liquid crystal panel 100 needs to frequently output positive polarity voltages and negative polarity voltages in turn, resulting in power consumption of the liquid crystal panel 100 being very great. Hence, how to reduce the power consumption of the liquid crystal panel 100 caused by the dot inversion is an important issue for a liquid crystal panel designer.

### SUMMARY OF THE INVENTION

According to an embodiment of the present invention, a method for reducing power consumption of a liquid crystal display system is provided. The LCD system includes a liquid crystal panel, a timing controller, a gate driving circuit, a source driving circuit, a plurality of scan lines, and a plurality of data lines, and the liquid crystal panel includes a plurality of sub pixels. The method includes the following steps: the timing controller receiving an image signal of a frame; the timing controller generating a gate control signal and a source control signal corresponding to the gate control signal according to the image signal of the frame; the gate driving circuit driving odd scan lines of a plurality of scan lines in turn and then driving even scan lines of the plurality of scan lines in turn according to the gate control signal; and a source driving circuit charging the plurality of sub pixels through the plurality of data lines according to the source control signal, driving sequence of the plurality of scan lines, and data voltages corresponding to the image signal, wherein voltages of the plurality of data lines are switched one time at most, and a common voltage of the liquid crystal panel is a direct current (DC) voltage.

In view of above, the present invention provides a method for reducing the power consumption of the LCD system. The method changes a sequence of the gate driving circuit driving the plurality of scan lines, and accordingly changes a sequence of the source driving circuit outputting data voltages corresponding to an image signal of a frame. Since the present invention can significantly reduce switching times of the data voltages corresponding to the image signal, so the present invention can significantly reduce the power consumption of the LCD system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a liquid crystal panel with a dot inversion.

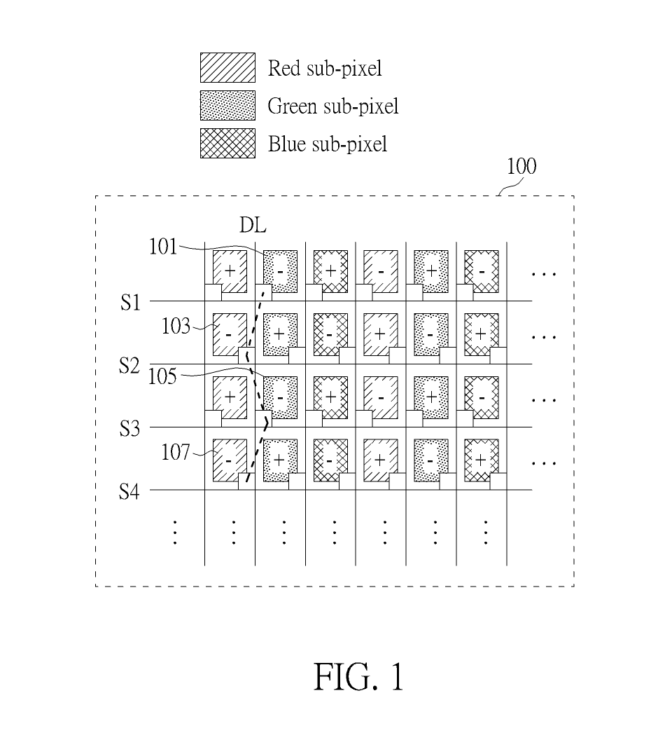

FIG. 2 is a diagram illustrating an LCD system.

FIG. 3 is a flowchart illustrating a method for reducing the power consumption of the LCD system according to an embodiment of the present invention.

FIG. 4 is a diagram illustrating the liquid crystal panel of the LCD system displaying a red color frame.

FIG. 5 is a diagram illustrating the liquid crystal panel of the LCD system displaying a frame having green and blue colors.

FIG. 6 is a diagram illustrating the liquid crystal panel of the LCD system displaying a frame having red, blue, and green colors.

### DETAILED DESCRIPTION

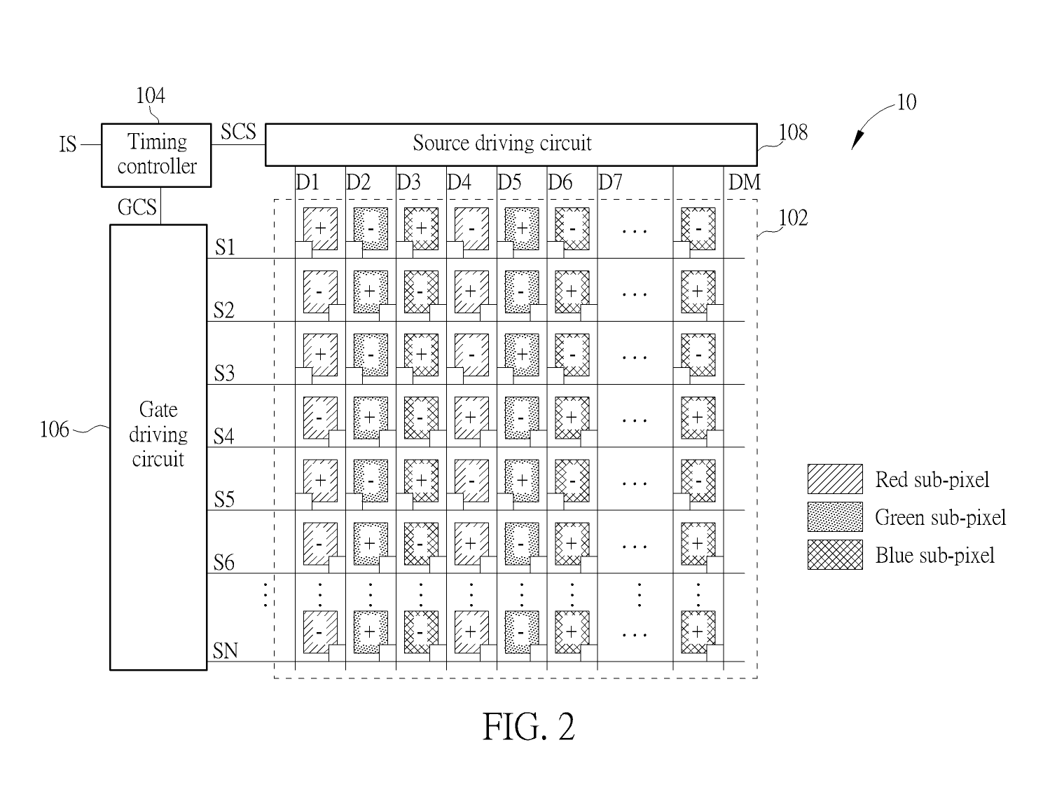

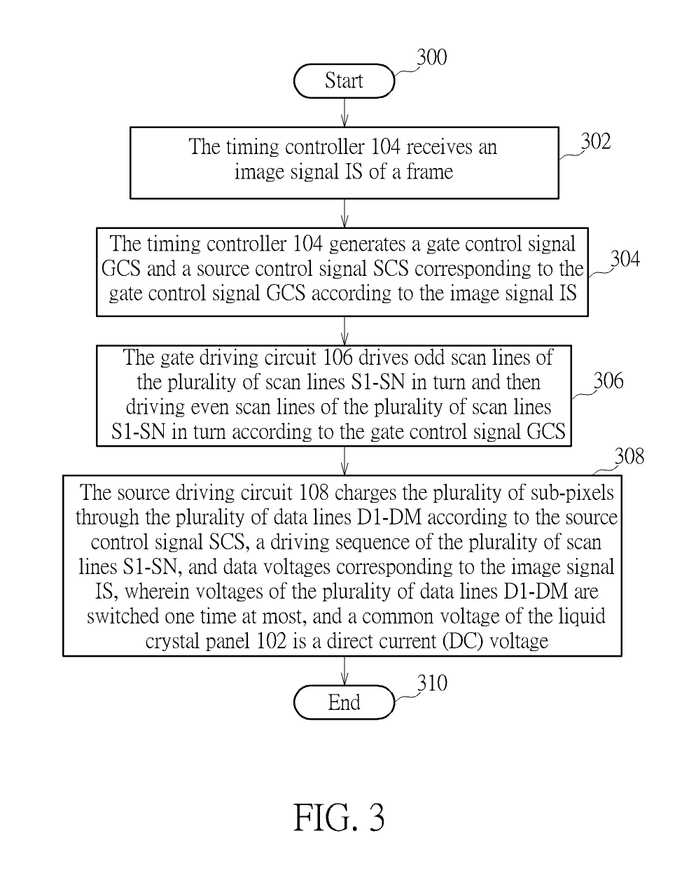

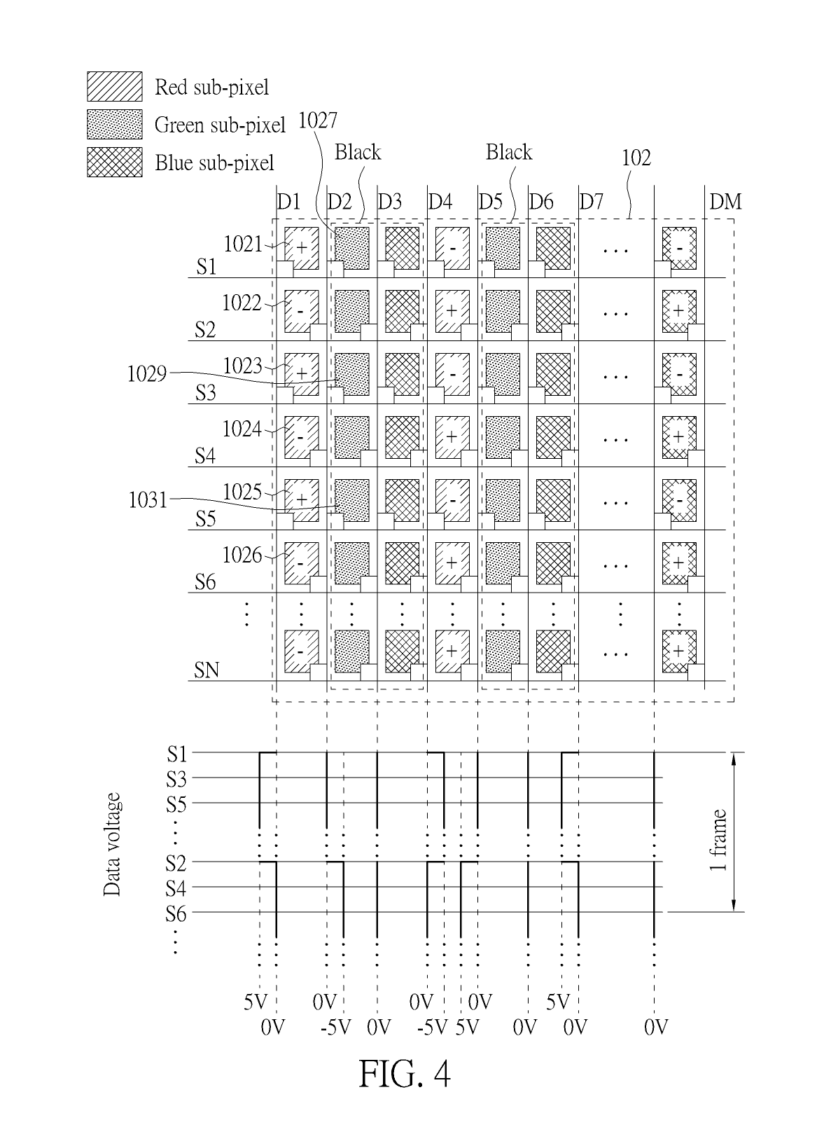

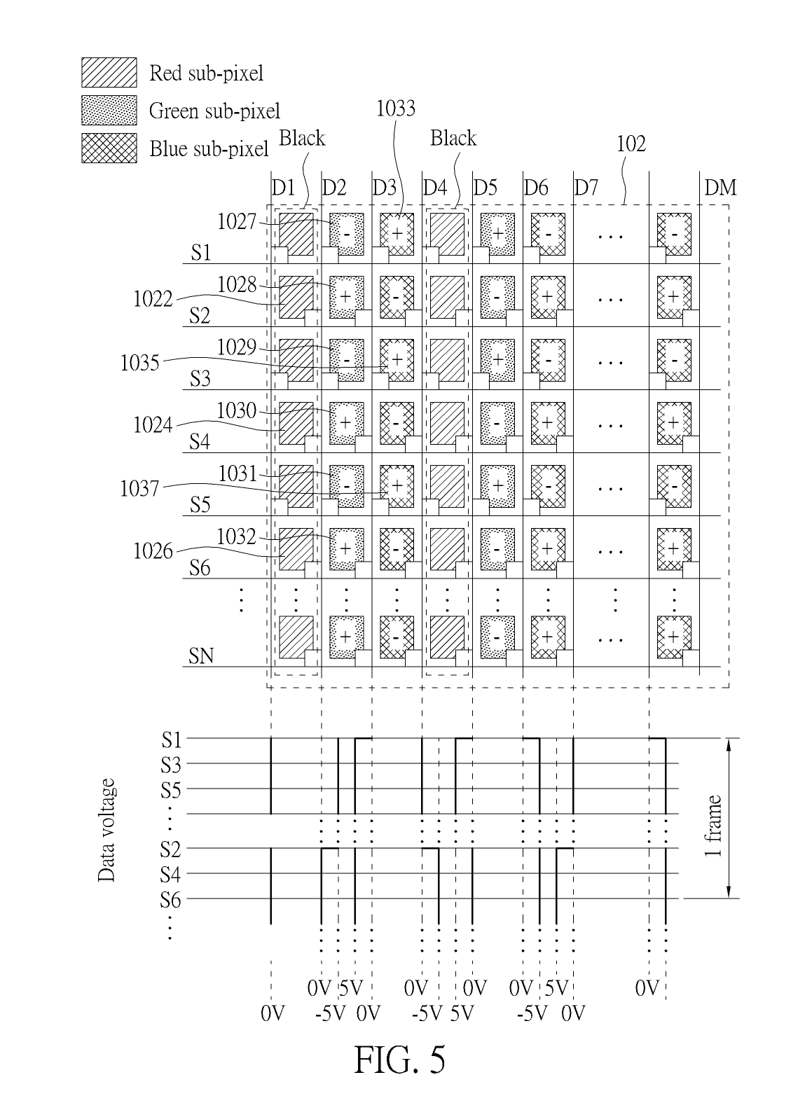

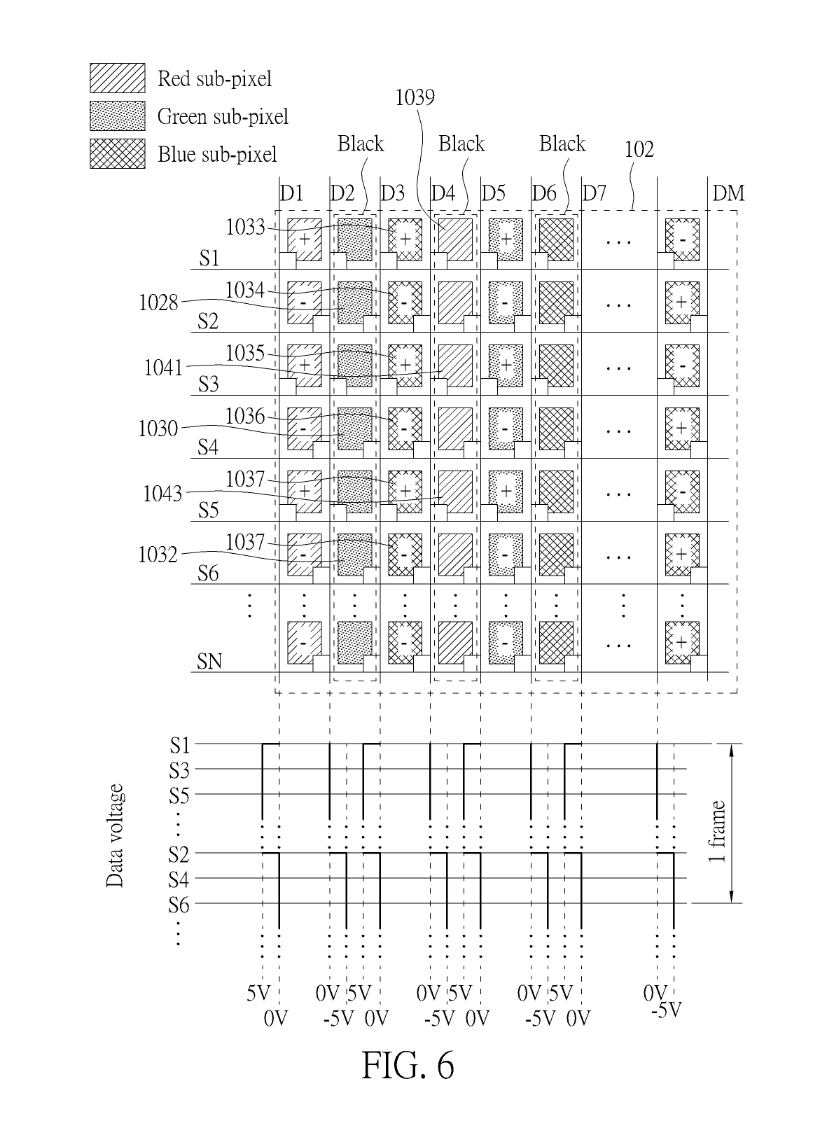

Please refer to FIGS. 2-6. FIG. 2 is a diagram illustrating an LCD system 10. FIG. 3 is a flowchart illustrating a method for reducing power consumption of the LCD system according to an embodiment of the present invention. FIG. 4 is a diagram illustrating a liquid crystal panel of the LCD system 10 displaying a red color frame. FIG. 5 is a diagram illustrating the liquid crystal panel of the LCD system 10 displaying a frame having green and blue colors. FIG. 6 is a diagram illustrating the liquid crystal panel of the LCD system 10 displaying a red, blue and green color frame.

As shown in FIG. 2, the LCD system 10 includes a liquid crystal panel 102, a timing controller 104, a gate driving circuit 106, a source driving circuit 108, a plurality of scan lines S1-SN, and a plurality of data lines D1-DM. The liquid crystal panel 102 includes a plurality of sub pixels, and N and M are positive integers. The liquid crystal panel 102 is a dot inversion liquid crystal panel and sub pixels of the plurality of sub pixels of the liquid crystal panel 102 coupled to a data line of the data lines D1-DM are arranged in a Zig-Zag shape. As shown in FIG. 2, the gate driving circuit 106 and the source driving circuit 108 are coupled to the timing controller 104, and each sub pixel of the liquid crystal panel 102 corresponds to one scan line of the scan lines S1-SN and one data line of the data lines D1-DM. The method in FIG. 3 is illustrated using the LCD system 10 in FIG. 2. Detailed steps are as follows:

Step 300: Start.

Step 302: The timing controller 104 receives an image signal IS of a frame.

Step 304: The timing controller 104 generates a gate control signal GCS and a source control signal SCS corresponding to the gate control signal GCS according to the image signal IS.

Step 306: The gate driving circuit 106 drives odd scan lines of the plurality of scan lines S1-SN in turn and then driving even scan lines of the plurality of scan lines S1-SN in turn according to the gate control signal GCS.

Step 308: The source driving circuit 108 charges the plurality of sub pixels through the plurality of data lines D1-DM according to the source control signal SCS, a driving sequence of the plurality of scan lines S1-SN, and data voltages corresponding to the image signal IS, wherein voltages of the plurality of data lines D1-DM are switched one time at most, and a common voltage of the liquid crystal panel 102 is a direct current (DC) voltage.

Step 310: End.

In step 304, the timing controller 104 can generate the gate control signal GCS and the source control signal SCS corresponding to the gate control signal GCS according to a timing and a position displayed on the liquid crystal panel 102 of the image signal IS of the frame. In step 306, the gate driving circuit 106 drives the odd scan lines S1, S3, . . . of the plurality of scan lines S1-SN in turn and then driving the even scan lines S2, S4, . . . of the plurality of scan lines S1-SN in turn according to the gate control signal GCS.

However, in another embodiment of the present invention, the gate driving circuit 106 drives the even scan lines S2, S4, . . . of the plurality of scan lines S1-SN in turn and then driving the odd scan lines S1, S3, . . . of the plurality of scan lines S1-SN in turn according to the gate control signal GCS. Hence, in step 308, the source driving circuit 108 charges corresponding sub pixels of the plurality of sub pixels of the liquid crystal panel 102 through data lines of the data lines D1-DM corresponding to the odd scan lines S1, S3, . . . according to the source control signal SCS, the driving sequence of the odd scan lines S1, S3, . . . , and the data voltages corresponding to the image signal IS, wherein when the liquid crystal panel 102 displays the image corresponding to the image signal IS, the common voltage of the liquid crystal panel 102 is a direct current voltage.

As shown in FIG. 4, when the image signal IS corresponds to a red color, the gate driving circuit 106 will first drive the odd scan lines S1, S3, . . . of the scan lines S1-SN in turn according to the gate control signal GCS. That is, in the liquid crystal panel 102, switches of sub pixels coupled to the odd scan lines S1, S3, . . . are turned on in turn. Hence, taking the data line D1 for example, since switches corresponding to red sub pixels 1021, 1023, 1025 . . . are turned on in turn, the source driving circuit 108 may charge the red sub pixels 1021, 1023, 1025 . . . of the liquid crystal panel 102 according to a driving sequence of the odd scan lines S1, S3, . . . and the data voltages corresponding to the image signal IS.

As shown in FIG. 4, since polarities of the red sub pixels 1021, 1023, 1025, . . . are positive, the data voltages for charging the red sub pixels 1021, 1023, 1025, . . . of the liquid crystal panel 102 are a positive voltage (such as 5V). However, the present invention does not limit the data voltages for charging the red sub pixels 1021, 1023, 1025 . . . of the liquid crystal panel 102 being 5V.

Although the present invention merely illustrate operations of the odd scan lines S1, S3 and S5 in FIG. 4, operations of other odd scan lines are similar to those of the odd scan lines S1, S3 and S5, and are omitted for brevity. Further, as shown in FIG. 4, when the image signal IS corresponds to a red color, the gate driving circuit 106 will drive the even scan lines S2, S4, . . . of the scan lines S1-SN in turn after driving first drive the odd scan lines S1, S3, . . . of the scan lines S1-SN in turn according to the gate control signal GCS. That is, in the liquid crystal panel 102, switches of sub pixels coupled to the even scan lines S2, S4, . . . are turned on in turn. Hence, taking the data line D2 for example, since switches corresponding to red sub pixels 1022, 1024, 1026 . . . are turned on in turn, the source driving circuit 108 may charge the red sub pixels 1022, 1024, 1026 . . . of the liquid crystal panel 102 according to a driving sequence of the even scan lines S2, S4, . . . and the data voltages corresponding to the image signal IS.

As shown in FIG. 4, since polarities of the red sub pixels 1022, 1024, 1026 . . . are negative, the data voltages for charging the red sub pixels 1022, 1024, 1026 . . . of the liquid crystal panel 102 are a negative voltage (such as −5V). However, the present invention does not limit the data voltages for charging the red sub pixels 1022, 1024, 1026 . . . of the liquid crystal panel 102 being −5V.

Moreover, as shown in FIG. 4, taking the data line D2 for example, when the image signal IS corresponds to a red color, green sub pixels 1027, 1029, 1031, . . . corresponding to the odd scan lines S1, S3, S5, . . . are turned off. Thus, data voltages of the data line D2 corresponding to the odd scan lines S1, S3, S5, . . . are 0.

Further, although the present invention merely illustrate operations of the even scan lines S2, S4 and S6 in FIG. 4, operations of other even scan lines are similar to those of the even scan lines S2, S4 and S6, and are omitted for brevity. Further, as shown in FIG. 4, switching times of the data voltages (a positive voltage and a negative volatge) of the plurality of data lines D1-DM corresponding to the image signal IS are significantly reduced. For example, the data voltages of the data lines D1 and D2 are switched one time at most.

Moreover, since the gate driving circuit 106 first drives the odd scan lines of the scan lines S1-SN in turn according to the gate control signal GCS, and then drives the even scan lines of the scan lines S1-SN in turn, data voltages corresponding to the image signal IS outputted by the source driving circuit 108 need to correspond to a driving sequence of the scan lines S1-SN. Further, when the image signal IS corresponds to a red color, green sub pixels and blue sub pixels of the liquid crystal panel 102 are turned off. At this moment, the green sub pixels and the blue sub pixels of the liquid crystal panel 102 present black. That is, the liquid crystal panel 102 utilizes the red sub pixels to display a red frame.

Similarly, as shown in FIG. 5, taking the data line D2 for example, when the image signal IS corresponds to a green color and a blue color (the red sub pixels of the liquid crystal panel 102 are turned off), since switches corresponding to the green sub pixels 1027, 1029, 1031, . . . are turned on in turn, the source driving circuit 108 may charge the green sub pixels 1027, 1029, 1031 . . . of the liquid crystal panel 102 according to a driving sequence of the odd scan lines S1, S3, . . . and data voltages corresponding to the image signal IS.

As shown in FIG. 5, since polarities of the green sub pixels 1027, 1029, 1031, . . . are negative, the data voltages for charging the green sub pixels 1027, 1029, 1031, . . . of the liquid crystal panel 102 are a negative voltage (such as −5V). Further, as shown in FIG. 5, taking the data line D2 for example, when the image signal IS corresponds to a green color and a blue color, the red sub pixels 1022, 1024, 1026, . . . are turned off. Thus, data voltages of the data line D2 corresponding to the even scan lines S2, S4, S6, . . . are 0.

Moreover, as shown in FIG. 5, taking the data line D3 for example, since switches corresponding to green sub pixels 1028, 1030, 1032 are turned on in turn, the source driving circuit 108 may charge the green sub pixels 1028, 1030, 1032 . . . of the liquid crystal panel 102 according to a driving sequence of the even scan lines S2, S4, . . . and data voltages corresponding to the image signal IS. As shown in FIG. 5, since polarities of the green sub pixels 1028, 1030, 1032 . . . are positive, the data voltages for charging the green sub pixels 1028, 1030, 1032 . . . of the liquid crystal panel 102 are a positive voltage (such as 5V).

Moreover, as shown in FIG. 5, taking the data line D3 for example, since switches corresponding to blue sub pixels 1033, 1035, 1037 are turned on in turn, the source driving circuit 108 may charge the blue sub pixels 1033, 1035, 1037 . . . of the liquid crystal panel 102 according to a driving sequence of the odd scan lines S1, S3, . . . and the data voltage corresponding to the image signal IS. As shown in FIG. 5, since polarities of the blue sub pixels 1033, 1035, 1037 . . . are positive, the data voltages for charging the blue sub pixels 1033, 1035, 1037 . . . of the liquid crystal panel 102 are a positive voltage (such as 5V).

Further, although the present invention merely illustrate operations of the odd scan lines S1, S3 and S5, and the even scan lines S2, S4 and S6 in FIG. 5, operations of other odd and even scan lines of the scan lines S1-SN are similar and are omitted for brevity.

Similarly, as shown in FIG. 6, when the image signal IS corresponds to a frame having red, blue, and green colors (even column sub pixels of the liquid crystal panel 102 are turned off, thus the even column sub pixels of the liquid crystal panel 102 present black), taking the data line D3 for example, since switches corresponding to the blue sub pixels 1033, 1035, 1037 are turned on in turn, the source driving circuit 108 may charge the blue sub pixels 1033, 1035, 1037 . . . of the liquid crystal panel 102 according to a driving sequence of the odd scan lines S1, S3, . . . and data voltages corresponding to the image signal IS. As shown in FIG. 6, since polarities of the blue sub pixels 1033, 1035, 1037 . . . are positive, the data voltages for charging the blue sub pixels 1033, 1035, 1037 . . . of the liquid crystal panel 102 are a positive voltage (such as 5V).

Moreover, as shown in FIG. 6, taking the data line D3 for example, the green sub pixels 1028, 1030, 1032, . . . corresponding to the even scan lines S2, S4, S6, . . . are turned off. Thus, data voltages of the data D3 corresponding to the even scan lines S2, S4, S6, . . . are 0.

Moreover, taking the data line D4 for example, since switches corresponding to blue sub pixels 1034, 1036, 1038 are turned on in turn, the source driving circuit 108 may charge the blue sub pixels 1034, 1036, 1038 . . . of the liquid crystal panel 102 according to the driving sequence of the even scan lines S2, S4, . . . and data voltages corresponding to the image signal IS. As shown in FIG. 6, since polarities of the blue sub pixels 1034, 1036, 1038 . . . are negative, the data voltages for charging the blue sub pixels 1034, 1036, 1038 . . . of the liquid crystal panel 102 are a negative voltage (such as −5V).

Moreover, as shown in FIG. 6, taking the data line D4 for example, the red sub pixels 1039, 1041, 1043, . . . corresponding to the odd scan lines S1, S3, S5, . . . are turned off. Thus, data voltages of the data D4 corresponding to the odd scan lines S1, S3, S5, . . . are 0.

Further, although the present invention merely illustrate operations of the odd scan lines S1, S3 and S5, and the even scan lines S2, S4 and S6 in FIG. 6, operations of other odd and even scan lines of the scan lines S1-SN are similar and are omitted for brevity.

In view of above, the method for reducing the power consumption of the LCD system provided by the present invention changes a sequence of the gate driving circuit driving the plurality of scan lines, and accordingly changes a sequence of the source driving circuit outputting data voltages corresponding to an image signal of a frame, to reduce the power consumption of the LCD system. Therefore, the present invention can significantly reduce switching times of the data voltages corresponding to the image signal, so the present invention can significantly reduce the power consumption of the LCD system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for reducing power consumption of a liquid crystal display (LCD) system, wherein the LCD system comprises a liquid crystal panel, a timing controller, a gate driving circuit, a source driving circuit, a plurality of scan lines, and a plurality of data lines, and the liquid crystal panel comprises a plurality of sub pixels, the method comprising the following steps:
the timing controller receiving an image signal of a frame;
the timing controller generating a gate control signal and a source control signal corresponding to the gate control signal according to the image signal of the frame;
the gate driving circuit driving odd scan lines of a plurality of scan lines in turn and then driving even scan lines of the plurality of scan lines in turn according to the gate control signal; and
a source driving circuit charging the plurality of sub pixels through the plurality of data lines according to the source control signal, driving sequence of the plurality of scan lines, and data voltages corresponding to the image signal, wherein voltages of the plurality of data lines are switched one time at most, and a common voltage of the liquid crystal panel is a direct current (DC) voltage.

2. The method of claim 1, wherein the step of the source driving circuit charging the plurality of sub pixels through the plurality of data lines according to the source control signal, the driving sequence of the plurality of scan lines, and the data voltages corresponding to the image signal further comprises:
when the gate driving circuit drives the odd scan lines of the plurality of scan lines in turn according to the gate control signal, the source driving circuit charging corresponding sub pixels of the plurality of sub pixels through data lines of the plurality of data lines corresponding to the odd scan lines according to the source control signal, driving sequence of the odd scan lines of plurality of scan lines, and the data voltages corresponding to the image signal.

3. The method of claim 1, wherein the step of the source driving circuit charging the plurality of sub pixels through the plurality of data lines according to the source control signal, the driving sequence of the plurality of scan lines, and the data voltages corresponding to the image signal further comprises:
when the gate driving circuit drives the even scan lines of the plurality of scan lines in turn according to the gate control signal, the source driving circuit charging corresponding sub pixels of the plurality of sub pixels through data lines of the plurality of data lines corresponding to the even scan lines according to the source control signal, driving sequence of the even scan lines of the plurality of scan lines, and the data voltages corresponding to the image signal.

4. The method of claim 1, wherein the liquid crystal panel is a dot inversion liquid crystal panel.

5. The method of claim 1, wherein sub pixels of the plurality of sub pixels coupled to a data line of the plurality of data lines are arranged in a Zig-Zag shape.
